(19) United States
(12) Patent Application Publication
(10) Pub. No.: US 2021/0079154 A1
(43) Pub. Date: Mar. 18, 2021

(54) A POLYISOCYANATE FOAM FOR SANDWICH PANEL WITH LOW PROCESSING TEMPERATURE AND ENHANCED ADHESION

(71) Applicant: BASF SE, Ludwigshafen am Rhein (DE)

(72) Inventors: Mohamed Bouguettaya, Wyandotte, MI (US); Lian Jiang Zhao, Shanghai (CN); Xue Qing Li, Shanghai (CN); Yan Sheng, Shanghai (CN); Wei Jie Zhou, Shanghai (CN)

(21) Appl. No.: 16/612,274

(22) PCT Filed: May 9, 2018
(86) PCT No.: PCT/EP2018/061968

§ 371 Date: Nov. 8, 2019

(30) Foreign Application Priority Data
May 11, 2017 (CN) PCT/CN2017/083992

(51) Int. Cl. C08G 18/76; C08G 18/66; C08G 18/48; C08G 18/42; C08G 18/40; C08G 18/32; C08G 18/22; C08G 18/18; C08G 18/16; C08G 18/09; C08K 5/521

(52) U.S. Cl. CPC C08G 18/7671; C08G 2101/0025; C08G 18/664; C08G 18/485; C08G 18/4841; C08G 18/4829; C08G 18/4825; C08G 18/4812; C08G 18/4211; C08G 18/4018; C08G 18/3206; C08G 18/225; C08G 18/1808; C08G 18/163; C08G 18/092; C08K 5/521; C08G 18/6674

(57) ABSTRACT

Described herein are a polyisocyanurate foam, its use in a sandwich panel, a sandwich panel including the foam, and a process for preparing the sandwich panel. The polyisocyanurate foam shows a good adhesion property even without adhesion promoter, improved processability of PIR systems at lower temperature (≤50° C.), and an improved flame resistance property.

### TECHNICAL FIELD OF THE INVENTION

The present invention is directed to a polyisocyanurate foam, its use in a sandwich panel, a sandwich panel comprising the foam and a process for preparing the sandwich panel.

### BACKGROUND OF THE INVENTION

Sandwich panels having cellular cores are notable for their light weight and high strength. Conventionally, such panels are constructed by sandwiching a cellular core having low strength between two facings, each of which is much thinner than the cellular core but has excellent mechanical properties.

Due to the higher and higher flame resistance (FR) requirement in the sandwich panel market, polyisocyanurate (PIR) foam becomes more and more popular for its good FR property. However, there are two main problems for PIR sandwich panel production: a) bad adhesion between the PIR foam and the metal facing, b) high processing requirement, e.g. >60° C. Many customers use an adhesion promoter to solve the adhesion problem. Moreover, the cost of the high processing temperature is high, especially in winter. Both of the problems add the cost of the sandwich panel production.

Polyurethane/polyisocyanurate foams having improved adhesion properties have been disclosed in many publications.

For example, CN 102666630 A discloses a polyurethane/polyisocyanurate foam that can be obtained by reacting A) a polyol component comprising A1) an aromatic polyester polyol, A2) a polyether polyol started on a carbohydrate polyol, and A3) a polyether polyol started on an ethylene glycol, wherein the total hydroxyl number of the polyol component A) is from 150 mg KOH/g to 300 mg KOH/g; with B) a polyisocyanate component, wherein the equivalent ratio of NCO groups to the sum of the hydrogen atoms that are reactive with respect to NCO groups is from 110:100 to 200:100. It was said that the foam has improved bonding properties with the facing and is suitable for producing composite elements without requiring the use of an additional bonding agent. However, the NCO index was reduced to 110-200, and this causes the foam to become a polyurethane/polyisocyanurate blend (PUIR) foam. The polyurethane part will improve the adhesion property. However, the flame resistance property of the PUIR foam is worse than the PIR foam.

### SUMMARY OF THE INVENTION

An object of the present invention is to provide a polyisocyanurate foam showing a good adhesion property even without adhesion promoter, an improved processability at a lower temperature (≤60° C.) and an improved flame resistance property.

The object can be achieved by a polyisocyanurate foam obtainable by reacting A) a polyol component comprising: A1) a polyester ployol, A2) a short-chain polyether polyol, and A3) a long-chain polyether polyol; with B) a polyisocyanate component with an NCO index from about 210 to about 500.

In a first aspect of the invention, there is provided a polyisocyanurate foam obtainable by reacting A) a polyol component comprising: A1) a polyester ployol, A2) a short-chain polyether polyol, and A3) a long-chain polyether polyol; with B) a polyisocyanate component with an NCO index from about 210 to about 500.

In a second aspect of the invention, there is provided the use of the polyisocyanurate foam of the present invention in sandwich panel.

In a third aspect of the invention, there is provided a sandwich panel comprising the polyisocyanurate foam of the present invention.

In a fourth aspect of the present invention, there is provided a process for preparing the sandwich panel of the present invention, comprising the step of applying a reaction mixture that yields the polyisocyanurate foam of the present invention to a facing.

### DETAILED DESCRIPTION OF THE INVENTION

In one aspect, the present invention is directed to a polyisocyanurate foam obtainable by reacting A) a polyol component comprising: A1) a polyester ployol, A2) a short-chain polyether polyol, and A3) a long-chain polyether polyol; with B) a polyisocyanate component with an NCO index from about 210 to about 500.

Polyester ployol A1) can be for example, an aromatic polyester ployol. The aromatic polyester ployol can be, for example, a polycondensation product of di- as well as optionally tri- or more functional alcohols and aromatic di- as well as optionally tri- and more functional carboxylic acids or hydroxycarboxylic acids or lactones. Instead of the free polycarboxylic acids, the corresponding polycarboxylic acid anhydrides or corresponding polycarboxylic acid esters of lower alcohols can also be used to prepare the polyesters.

Examples of suitable diols for the preparation of the polyester ployol are ethylene glycol, butylene glycol, diethylene glycol, triethylene glycol, 1,2-propanediol, 1,3-propanediol, 1,3-butanediol, 1,4-butanediol and the isomers thereof, 1,6-hexanediol and the isomers thereof, or neopentyl glycol, also polyalkylene glycols such as polyethylene glycol, with ethylene glycol, butylene glycol, 1,6-hexanediol and the isomers thereof, and neopentyl glycol being preferred. In addition, polyols such as trimethylolpropane, glycerol, erythritol, pentaerythritol, or trimethylolbenzene can also be used.

As aromatic dicarboxylic acids, for example, phthalic acid, isophthalic acid, terephthalic acid, naphthalenedicarboxylic acids and/or tetrachlorophthalic acid may be used. The corresponding anhydrides can also be used as the acid source.

The polyester polyol A1) preferably has a hydroxyl number from about 50 to about 750 mg KOH/g, more preferably from about 100 to about 500 mg KOH/g, even more preferably from about 150 to about 400 mg KOH/g, most preferably from about 150 to about 300 mg KOH/g. The number-averaged molecular weight of the polyester polyol A1) may be from about 100 to about 3000, preferably from about 200 to about 2000, more from about 300 to about 1000, most from about 400 to about 800, as measured by gel permeation chromatography (GPC) using polystyrene standard.

The amount of the polyester ployol A1) can be from about 1 to about 35%, preferably from about 5 to about 30%, more preferably from about 15 to about 25%, based on the total weight of the components A) and B).

The polyether polyols in the short-chain polyether polyol A2) and the long-chain polyether polyol A3) are obtained by known processes, for example via anionic or cationic polymerization of alkylene oxides with addition of at least one starter molecule comprising from 2 to 8, preferably from 2 to 6, and particularly preferably from 2 to 4, reactive hydrogen atoms, in the presence of catalysts. Catalysts used can comprise alkali metal hydroxides, such as sodium hydroxide or potassium hydroxide, or alkali metal alcoholates, such as sodium methoxide, sodium ethoxide, potassium ethoxide, or potassium isopropoxide, or, in the case of cationic polymerization, Lewis acids, such as antimony pentachloride, boron trifluoride etherate, or bleaching earth. Other catalysts that can be used are double-metal cyanide compounds, known as DMC catalysts. The alkylene oxides used for preparing A2) and A3) comprise one or more compounds having from 2 to 8 carbon atoms in the alkylene moiety, e.g. tetrahydrofuran, ethylene oxide, propylene oxide, 1,2-butylene oxide, 2,3-butylene oxide or styrene oxide, in each case alone or in the form of a mixture, and preferably propylene oxide and/or ethylene oxide.

Examples of starter molecules that can be used are ethylene glycol, diethylene glycol, glycerol, trimethylolpropane, pentaerythritol, sugar derivatives, such as sucrose, hexitol derivatives, such as sorbitol, methylamine, ethylamine, isopropylamine, butylamine, benzylamine, aniline, toluidine, toluenediamine, naphthylamine, ethylenediamine, diethylenetriamine, 4,4′-methylenedianiline, 1,3-propanediamine, 1,6-hexanediamine, ethanolamine, diethanolamine, triethanolamine, and also other di- or polyhydric alcohols, or di- or polybasic amines.

In a preferred embodiment, the short-chain polyether polyol A2) consists of the reaction product of ethylene oxide and/or propylene oxide, particularly propylene oxide, initiated on dimethylol propane, trimethylol propane or glycerine or ethanediol, preferably on ethanediol.

The short-chain polyether polyol A2) has an OH number from about 100 to about 1250 mg KOH/g, more preferably from about 100 to about 950 mg KOH/g, particularly preferred from about 100 to about 500 mg KOH/g, most preferably from about 100 to about 300 mg KOH/g.

The number-averaged molecular weight of the short-chain polyether polyol A2) may be from about 100 to about 1000, preferably from about 200 to about 900, more from about 300 to about 800, most from about 400 to about 600.

The amount of the short-chain polyether polyol A2) can be from about 1 to about 20% by weight, preferably from about 1 to about 10%, more preferably from about 1 to about 6%, based on the total weight of the components A) and B).

In a preferable embodiment, the long-chain polyether polyol A3) consists of the reaction product of ethylene oxide and/or propylene oxide, particularly ethylene oxide and propylene oxide, initiated on dimethylol propane, trimethylol propane or glycerine, preferably on glycerine.

The long-chain polyether polyol A3) has an OH number from about 10 to about 1000 mg KOH/g, more preferably from about 20 to about 500 mg KOH/g, particularly preferred from about 30 to about 200 mg KOH/g, most preferably from about 40 to about 100 mg KOH/g.

The number-averaged molecular weight of the long-chain polyether polyol A3) may be from more than about 1000 to about 5000, preferably from about 2000 to about 5000, more preferably from about 3000 to about 5000, most preferably from about 3000 to about 4000.

It has surprisingly found that when using the long-chain polyether polyol A3) as the starting material, the adhesion strength of the resultant PIR foam would be greatly improved. The amount of the long-chain polyether polyol A3) can be from about 1 to about 20%, preferably from about 1 to about 10%, more preferably from about 1 to about 5%, based on the total weight of the components A) and B).

The polyisocyanate component B) can be monomeric polyisocyanate or polyisocyanate prepolymer. The monomeric polyisocyanate can be, for example, aliphatic, cycloaliphatic, or aromatic isocyanates. Examples are diphenylmethane 2,2′-, 2,4-, and 4,4′-diisocyanate, the mixtures of monomeric diphenylmethane diisocyanates and of diphenylmethane diisocyanate homologs having a greater number of rings (polymeric MDI), isophorone diisocyanate (IPDI) or its oligomers, tolylene diisocyanate (TDI), for example tolylene diisocyanate isomers such as tolylene 2,4- or 2,6-diisocyanate, or a mixture of these, tetramethylene diisocyanate or its oligomers, hexamethylene diisocyanate (HDI) or its oligomers, naphthylene diisocyanate (NDI), or a mixture thereof. The preferable monomeric polyisocyanate are MDI.

The polyisocyanate prepolymers are obtainable by reacting an excess of the polyisocyanates with compounds having at least two groups reactive toward isocyanates, to give the prepolymer. The polyisocyanates used to prepare the prepolymer can be, for example, those abovementioned for the monomeric polyisocyanate.

The NCO index of the polyisocyanate prepolymers of the invention is preferably from about 210 to about 500, more preferably from about 250 to about 500, most preferably from about 300 to about 500. The higher NCO index is the key technical pathway to improve FR performance in panel application, which will meet the FR requirement in panel application.

The reaction for preparing the PIR foam is advantageously carried out in the presence of a catalyst. The catalyst that can be used in the present invention may be, for example, basic amines, e.g. secondary aliphatic amines, imidazoles, amidines, and also alkanolamines, Lewis acids, or organometallic compounds, in particular those based on tin. Polyamines such as N,N,N′,N″,N″-pentamethyldiethylenetriamine could also be used, optionally together with potassium acetate.

Catalyst systems composed of a mixture of various catalysts can also be used. In a preferable embodiment, the catalyst may additionally comprise the so-called delay catalyst. Among them, DBU (1,8-diazabicyclo[5.4.0]undec-7-ene) based amine salt catalyst are preferable, more preferably tertiary amine.

It was surprisingly found that when using the delay catalyst, especially the DBU based amine salt as the catalyst, the adhesion strength of the resultant PIR foam would be greatly improved.

The amount of the catalyst can be from about 0.1 to about 5%, preferably from about 0.1 to about 4.5%, more preferably from about 0.1 to about 3.0%, even more preferably from about 0.15 to about 2.5%, most preferably from about 0.2 to about 1.0%, in each case based on the total weight of the components A) and B).

In the process of the present invention for prepare the PIR foam, various auxiliaries and/or additives, for example, flame retardants, plasticizers, surfactants, blowing agents, stabilizers, cell regulators, fillers, pigments, dyes, antioxidants, hydrolysis stabilizers, antistatic agents, fungistatic agents, and bacteriostatic agents etc. can be used.

The flame retardants that can be used can be phosphorus-containing flame retardant, such as

i) phosphorus-containing flame retardants having a low-molecular-weight. These compounds preferably have a molar mass below 300 g/mol, specifically below 300 g/mol, preferably below 200 g/mol, and particularly preferably from 150 to 190 g/mol, and preferably have fewer than 4 phosphorus atoms in the molecule, especially fewer than 3, more especially fewer than 2, and especially 1 phosphorus atom. Preference is given to phosphonates and/or phosphates. The phosphonates and/or phosphates may further comprise halogen atoms in the molecules. Particular preference is given to phosphates and phosphonates selected from diethyl ethanephosphonate (DEEP), dimethyl propylphosphonate (DMPP), and triethyl phosphate (TEP), and further preference is given to those selected from diethyl ethanephosphonate (DEEP) and triethyl phosphate (TEP),

ii) Another group of phosphorus containing compounds which do not react with isocyanates has a higher-molecular-weight, preferably with a molar mass above 300 g/mol. Preferably they have at least 1 phosphorus atom in the molecule. Preference is given to phosphonates and/or phosphates, especially phosphates. Preferred examples for these are diphenyl cresyl phosphate (DPC), tris(2-chlorisopropyl)phosphate (TCPP) and/or triphenyl phosphate, in particular diphenyl cresyl phosphate,

iii) Ammonium phosphate or ammonium polyphosphate.

In a preferred embodiment of the invention, the flame retardant is selected from diethyl ethylphosphonate (DEEP), dimethyl propylphosphonate (DMPP), triethyl phosphate (TEP) and tris(2-chlorisopropyl) phosphate (TCPP).

The flame retardants can be used alone or in a form of a mixture.

The amount of the flame retardant can be from 0 to about 10%, preferably from about 0.1 to about 8.0%, more preferably from about 0.5 to about 7.0%, even more preferably from about 0.8 to about 6.5%, most preferably from about 0.8 to about 6.0% by weight, in each case based on the total weight of the components A) and B)

It has surprisingly found that when using the combination of TEP with TCPP, the adhesion strength of the resultant PIR foam would be greatly improved. In a preferable embodiment of the present invention, the weight ratio of TEP to TCPP may be from about 0.1 to about 10.0, preferably from about 0.2 to about 5.0, more preferably from about 0.5 to about 2.0.

The blowing agents that can be used are chemical blowing agents, such as water and/or formic acid, these reacting with isocyanate groups with elimination of carbon dioxide and, respectively, carbon dioxide and carbon monoxide. The compounds known as physical blowing agents can also be used in combination with water or preferably instead of water. These are compounds being inert with respect to the starting components, mostly liquid at room temperature, and evaporating under the conditions of the urethane reaction. The boiling point of these compounds is preferably below 60° C. Among the physical blowing agents there are also compounds which are gaseous at room temperature and which are introduced or dissolved into the starting components under pressure, examples being carbon dioxide, low-boiling alkanes, and fluoroalkanes.

The blowing agents are mostly selected from alkanes, formic acid and and/or cycloalkanes having at least 4 carbon atoms, dialkyl ethers, esters, ketones, acetals, fluoroalkanes having from 1 to 8 carbon atoms, and tetraalkylsilanes having from 1 to 3 carbon atoms in the alkyl chain, in particular tetramethylsilane.

Examples which may be mentioned are propane, n-butane, isobutane, cyclobutane, n-pentane, isopentane, cyclopentane, cyclohexane, dimethyl ether, methyl ethyl ether, methyl butyl ether, methyl formate, acetone, and also fluoroalkanes which can be degraded in the troposphere and therefore do not damage the ozone layer, e.g. trifluoromethane, difluoromethane, 1,1,1,3,3-pentafluorobutane, 1,1,1,3,3-pentafluoropropane, 1,1,1,2-tetrafluoroethane, difluoroethane, and heptafluoropropane. The physical blowing agents mentioned may be used alone or in any desired combinations with one another.

The amount of water is preferred in a range of 0.1 to 2.0% by weight, based on the weight of the components A) and B).

Further details concerning the starting materials used for carrying out the inventive process, such as plasticizers, surfactants, blowing agents, stabilizers, cell regulators, fillers, pigments, dyes, antioxidants, hydrolysis stabilizers, antistatic agents, fungistatic agents, and bacteriostatic agents etc. may be found by way of example in Kunststoffhandbuch [Plastics Handbook], volume 7, “Polyurethane”, Carl-Hanser-Verlag Munich, 3^{rd} edition, 1993.

The PIR foam obtained according to the present invention shows an improved adhesion strength and an improved processability at lower temperature (60° C.) in comparison to the already commercialized PIR system; simultaneously it shows an excellent flame resistance.

In a preferable embodiment, the polyisocynaurate foam is obtainable by reacting A) a polyol component comprising: A1) a polyester ployol, A2) a short-chain polyether polyol, A3) of a long-chain polyols; with B) a polyisocyanate component having an NCO Index from about 210 to about 500 in the presence of C1) flame retardants TEP and TCPP and C2) catalyst package which is in a form of delay catalyst package.

It has been proved that the components A3, C1 and C2 in the reaction mixture of the present invention could bring about the effect of improving the adhesion, lowing the processing temperature and improving the flame resistance. The present invention combines the 3 factors together to implement the advantageous effect. Therefore, in a preferable embodiment, the process for preparing the polyisocyanurate foam could be carried at a low temperature, such as 60° C.

In one preferable embodiment, the polyisocynaurate foam is obtainable by reacting A) a polyol component comprising: A1) a polyester ployol in amount from about 15 to about 25%, A2) a short-chain polyether polyol in amount from about 1 to about 20% by weight, A3) a long-chain polyols in amount from about 1 to about 5%; with B) a polyisocyanate component having an NCO Index of about 450 in the presence of C1) flame retardants TEP and TCPP in amount from about 0.8 to about 6.0% and C2) catalyst package which is in a form of delay catalyst package in amount from about 0.2 to about 1.0%, in each case based on the total weight of the components A) and B).

In one embodiment, the reaction may be carried out at a temperature from about 20° C. to about 60° C., more preferably from about 30° C. to about 60° C., most preferably from about 40° C. to about 60° C.

In another aspect, the present invention relates to a process for preparing a sandwich panel, wherein a reaction mixture that yields the PIR foam according to the invention is applied to a facing. The process can be carried out continuously or discontinuously. The devices for continuous production are known, for example, from DE 1 609 668 or DE 1 247 612.

In one embodiment of the process for preparing the sandwich panel, no adhesion promoter layer is arranged between the reaction mixture and the facing. In this case, the improved adhesion property of the present PIR foam guarantees the sufficient adhesion between the foam and the facing.

The facing could be made from paper, fiber or metal, preferably metal. Suitable metals are, for example, steel or aluminum.

The process for preparing the sandwich panel may be in the form of a twin-belt conveyor process. Pretreatment of the facings can be omitted owing to the adhesive properties of the foam according to the invention. This simplifies the process.

In a further embodiment of the process according to the invention, the facing has a temperature of ≤60° C. on application of the reaction mixture. This temperature can be achieved in the production plant, for example, by means of a preceding oven installation. For twin-belt conveyor systems in particular, the temperature is comparatively low, which again brings about advantages in terms of process management and economy.

In an alternative embodiment, the sandwich panel can be prepared by means of a molding process. In this case, the premixed reaction mixture that yields the PIR foam according to the invention is applied to a facing which is previously arranged in a mold, then reacted to form the panel. The facing may be preheated, such as to a temperature ≤60° C. During the reaction, the temperature in the mold may be kept constantly by heating the mold. After a certain time, such as a period from 10 minutes to 2 hours, the finished panel is removed from the mold.

The present invention also relates to the use of the foam according to the present invention in a sandwich panel, and a sandwich panel comprising the foam according to the present invention.

The sandwich panels of the present invention are available for a variety of applications in construction, such as industrial buildings, public buildings offices and administration buildings, cold storages, clean rooms, agricultural buildings, power plants, residential houses and used in transportation such as reefer container, trailer etc.

### DESCRIPTION OF FIGURES

FIGS. 1 and 2 illustrate the adhesion energies of the sandwich panels in the examples.

### Examples

The present invention will be explained in detail by means of the following examples. Unless otherwise stated, all the amounts of the components in the examples refer to parts by weight.

Premixed PIR foam-forming reactants indicated in Table 1 below were applied to and foamed in a box mold having a size of 40 cm×40 cm×9 cm with a lower metal sheet which was preheated to 60° C. During the reaction, the temperature in the mold was kept constantly at 60° C. After keeping in the mold for 30 min, the finished sandwich panel was removed from the mold.

TABLE 1
Recipes of the PIR foams

| | Control 1 | Ex.1 | Ex.2 | Ex.3 |
|---|---|---|---|---|
| A Component | | | | |
| Polyester polyol A1 (polyethylene phthalate, | 64.35 | 64.35 | 64.35 | 64.35 |
| OHv 170, Mn 594) | | | | |
| Short-chain Polyether Polyol A2 | 16.04 | 11.04 | 16.04 | 16.04 |
| (polycondensate of PO initiated on Ethane- | | | | |
| 1,2-diol, OHv 190, Mn 590) | | | | |
| Long-chain polyether polyol A3 | — | 5.00 | — | — |
| (polycondensate of PO/EO initiated on | | | | |
| glycine, OHv 56, Mn 3000) | | | | |
| TCPP (FR agent) | 16.04 | 16.04 | 8.02 | 16.04 |
| TEP (FR agent) | — | — | 8.02 | |
| Silicone surfactant (TEGOSTAB ® available | 1.61 | 1.61 | 1.61 | 1.61 |
| from Evonik) | | | | |
| Catalyst package (Potassium acetate catalyst | 1.55 | 1.54 | 1.55 | 1.6 |
| and N,N,N′,N″,N″-Pentamethyl | | | | |
| diethylenetriamine catalyst in a ratio of 7:1) | | | | |
| Delay catalyst A5 (DBU based tertiary amine | — | — | — | 1 |
| salt catalyst, CAS No.: 33918-18-2) | | | | |
| Water | 1.00 | 1.00 | 1 | 1 |
| Pentane (blowing agent) | 15.00 | 17.00 | 15 | 17 |
| B Component | | | | |
| M50S, available from BASF | 198 | 198 | 198 | 198 |
| NCO index | 464.3 | 464.0 | 464 | 464 |

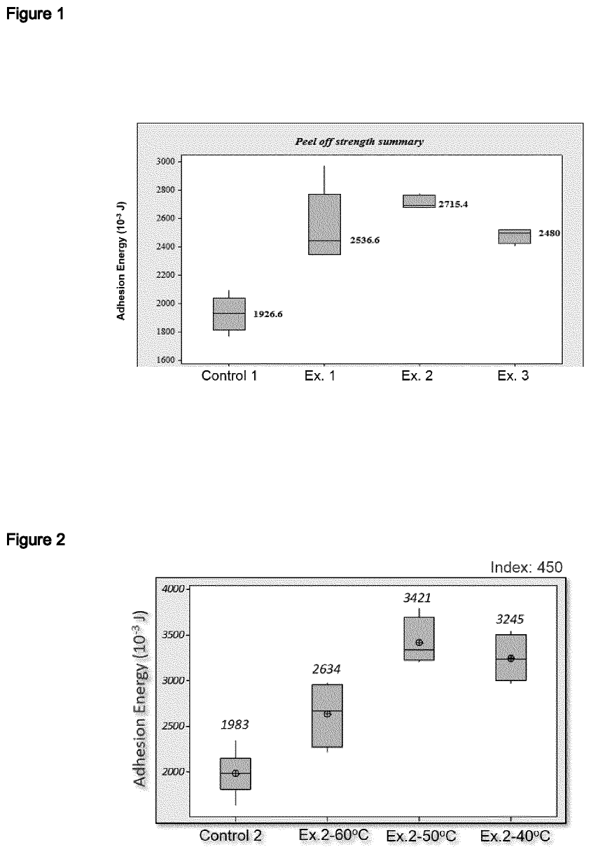

The adhesion energies of the resultant sandwich panels were measured according the peel-off test. The peel-off test could be carried out by using a Zwick machine (available from BASF company) to peel a 10 cm×20 cm metal sheet on the bottom side (For sandwich panel the adhesion of bottom side is worse than top side) off the foam surface from one side. The force and the distance were calculated to obtain the adhesion energy. The results are shown in FIG. 1 and Table 2.

TABLE 2
Adhesion Energy of the resultant sandwich panels

| | Control 1 | Ex.1 | Ex.2 | Ex.3 |
|---|---|---|---|---|
| Adhesion Energy (10⁻³J) | 1926.6 | 2536.6 | 2715.4 | 2480 |
| Improvement | — | 31.6% | 40.9% | 28.7% |

Comparing with the control 1, when using the long-chain polyol (EX.1), TCPP and TEP combination (EX.2), Delay catalyst (EX.3), the adhesion energies improve 31.6%, 40.9% and 28.7%, respectively.

In Ex. 4, the procedures for Ex. 1 to 3 were repeated by using the recipes in Table 3 under 60° C., 50° C. and 40° C., respectively, while control 2 is carried out under 60° C.

TABLE 3
Recipes of the PIR foams

| | Control 2 | Ex.4 |
|---|---|---|
| A Component | | |
| Polyester polyol A1 (polyethylene phthalate, | 64.35 | 64.35 |
| OHv 170, Mn 594) | | |
| Short-chain Polyether Polyol A2 (polycondensate of | 16.04 | 11.04 |
| PO initiated on Ethane-1,2-diol, OHv 190, Mn 590) | | |
| Long-chain polyether polyol A3 (polycondensate of | — | 5.00 |
| PO/EO initiated on glycine, OHv 56, Mn 3000) | | |
| TCPP (FR agent) | 16.04 | 8.02 |
| TEP (FR agent) | — | 8.02 |
| Silicone surfactant (TEGOSTAB ® available from | 1.61 | 1.61 |
| Evonik) | | |
| Catalyst package (Potassium acetate catalyst and | 1.55 | 1.5 |
| N,N,N′,N″,N″-Pentamethyldiethylenetriamine | | |
| catalyst in a ratio of 7:1) | | |
| Delay catalyst A5 (DBU based tertiary amine salt | — | 1 |
| catalyst, CAS No.: 33918-18-2) | | |
| Water | 1.00 | 1.00 |
| Pentane (blowing agent) | 15.00 | 15.00 |
| B Component | | |
| M50S, available from BASF | 198 | 190 |
| NCO index | 464.3 | 464. |

The adhesion energies of the resultant sandwich panels were measured, and the results are shown in FIG. 2 and Table 4, wherein EX-60 means under 60° C., EX4-50 under 50° C., EX4-40 under 40° C.

TABLE 4
Adhesion Energy of the resultant sandwich panels

| | Control 2 | Ex.4-60 | Ex.4-50 | Ex.4-40 |
|---|---|---|---|---|
| Adhesion Energy(10⁻³J) | 1983 | 2634 | 3421 | 3245 |
| Improvement | — | 32.8% | 72.5% | 63.6% |

Usually the lower temperature is bad for the PIR foam curing, because it will cause worse adhesion. Surprisingly, the examples show up to 70% increase in adhesion at significantly lower temperatures (50° C.). Moreover, the flame resistances of the present examples are similar with the control.

1. A polyisocyanurate foam obtainable by reacting A) a polyol component comprising: A1) a polyester polyol, A2) a short-chain polyether polyol, and A3) a long-chain polyether polyol; with B) a polyisocyanate component with an NCO index from about 210 to about 500.

2. The foam according to claim 1, wherein the polyester polyol A1) is an aromatic polyester ployol.

3. The foam according to claim 1, wherein polyester polyol A1) has a hydroxyl number from about 50 to about 750 mg KOH/g.

4. The foam according to claim 1, wherein the amount of the polyester ployol A1) is from about 1 to about 35%, based on a total weight of the polyol component A) and the polyisocyanate component B).

5. The foam according to claim 1, wherein the short-chain polyether polyol A2) has a number-averaged molecular weight from about 100 to about 1000.

6. The foam according to claim 1, wherein the short-chain polyether polyol A2) comprises a reaction product of ethylene oxide and/or propylene oxide, initiated on dimethylol propane, trimethylol propane, glycerine or ethanediol.

7. The foam according to claim 1, wherein and amount of the short-chain polyether polyol A2) is from about 1 to about 20% by weight, based on a total weight of the polyol component A) and the polyisocyanate component B).

8. The foam according to claim 1, wherein the long-chain polyether polyol A3) has a number-averaged molecular weight from more than about 1000 to about 5000.

9. The foam according to claim 1, wherein the long-chain polyether polyol A3) comprises a reaction product of ethylene oxide and/or propylene oxide, initiated on dimethylol propane, trimethylol propane, or glycerine.

10. The foam according to claim 1, wherein an amount of the long-chain polyether polyol A3) is from about 1 to about 20%, based on a total weight of the polyol component A) and the polyisocyanate component B).

11. The foam according to claim 1, wherein the NCO index of the polyisocyanate component B) is from about 250 to about 500.

12. The foam according to claim 1, wherein the reaction is carried out in presence of a catalyst.

13. The foam according to claim 12, wherein the catalyst comprises a delay catalyst.

14. The foam according to claim 13, wherein the delay catalyst is a DBU based amine salt.

15. The foam according to claim 12, wherein an amount of the catalyst is from about 0.1 to about 5%, based on a total weight of the polyol component A) and the polyisocyanate component B).

16. The foam according to claim 1, wherein a flame retardant is used during the reaction.

17. The foam according to claim 16, wherein the flame retardant is selected from phosphorus containing flame retardant.

18. The foam according to claim 17, wherein the flame retardant is selected from:
i) diethyl ethanephosphonate (DEEP), dimethyl propylphosphonate (DMPP), and triethyl phosphate (TEP), tris(2-chlorisopropyl)phosphate (TCPP);
ii) tris(2-chlorisopropyl)phosphate (TCPP), diphenyl cresyl phosphate (DPC) and/or triphenyl phosphate; and
iii) Ammonium phosphate or ammonium polyphosphate.

19. The foam according to claim 18, wherein the flame retardant is selected from the combination of TEP with TCPP.

20. The foam according to claim 16, wherein an amount of the flame retardant is from 0 to about 10%, based on a total weight of the polyol component A) and the polyisocyanate component B).

21. The foam according to claim 1, wherein the reaction is carried out at a temperature from about 20° C. to about 60° C.

22. The foam according to claim 1, wherein the polyisocynaurate foam is obtainable by reacting A) the polyol component comprising: A1) the polyester polyol in an amount from about 15 to about 25%, A2) the short-chain polyether polyol in an amount from about 1 to about 20% by weight, A3) the long-chain polyether polyol in an amount from about 1 to about 5%; with B) the polyisocyanate component having an NCO Index of about 450 in the presence of C1) flame retardants TEP and TCPP in an amount from about 0.8 to about 6.0%, and C2) a catalyst package in a form of a delay catalyst package in an amount from about 0.2 to about 1.0%, in each case based on the total weight of the polyol component A) and the polyisocyanate component B).

23. A method of using the polyisocyanurate foam according to claim 1, the method comprising using the polyisocyanurate foam in a sandwich panel.

24. A sandwich panel comprising the polyisocyanurate foam according to claim 1.

25. A process for preparing a sandwich panel, the process comprising the step of applying a reaction mixture that yields the polyisocyanurate foam according to claim 1 to a facing.

26. A method of using the sandwich panel according to claim 24, the method comprising using the sandwich panel in construction and transportation.
